(19) United States
(12) Patent Application Publication
(10) Pub. No.: US 2024/0000081 A1
(43) Pub. Date: Jan. 4, 2024

(54) PESTICIDAL COMPOSITION

(71) Applicant: SUMITOMO CHEMICAL COMPANY, LIMITED, Chuo-ku (JP)

(72) Inventors: Saki MATSUSHITA, Takarazuka-shi (JP); Ai RUSU, Takarazuka-shi (JP)

(73) Assignee: SUMITOMO CHEMICAL COMPANY, LIMITED, Chuo-ku (JP)

(21) Appl. No.: 18/255,334

(22) PCT Filed: Nov. 30, 2021
(86) PCT No.: PCT/JP2021/043752

§ 371 Date: May 31, 2023

(30) Foreign Application Priority Data
Dec. 1, 2020 (JP) 2020-199854

(51) Int. Cl. A01N 43/54; A01N 33/08; A01P 17/00

(52) U.S. Cl. CPC A01N 43/54; A01N 33/08; A01P 17/00

(57) ABSTRACT

Provided is a pesticidal composition comprising a compound represented by the formula (I), a herbicidal active salt, a surfactant and water, wherein a pH value at 25° C. is higher than 3.5 and lower than 8.8.

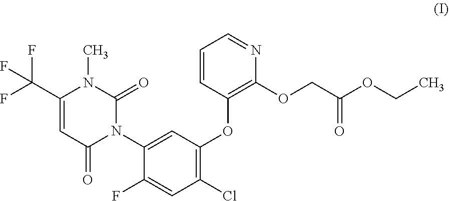 [SMILES: CCOC(=O)COc1ncccc1Oc1cc(-n2c(=O)cc(C(F)(F)F)n(C)c2=O)c(F)cc1Cl]

### TECHNICAL FIELD

The present invention relates to a pesticidal composition.

### BACKGROUND ART

A compound represented by the following formula (I), which is an active ingredient for herbicides, is known as a pesticidal active compound (see, e.g., U.S. Pat. No. 6,537,948 (Patent Literature 1)).

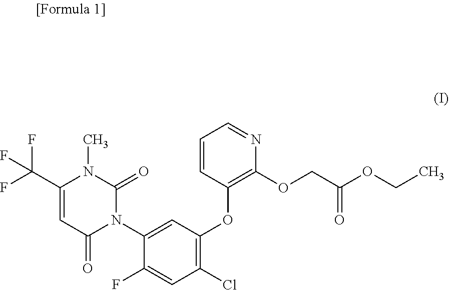 [SMILES: CCOC(=O)COc1ncccc1Oc1cc(-n2c(=O)cc(C(F)(F)F)n(C)c2=O)c(F)cc1Cl]

### CITATION LIST

### Patent Literature

PTL 1: U.S. Pat. No. 6,537,948

### SUMMARY OF INVENTION

### Technical Problem

An object of the present invention is to provide a liquid pesticidal composition comprising a compound represented by the formula (I) and a herbicidal active salt, wherein the liquid pesticidal composition has favorable degradation resistance of the compound represented by the formula (I).

### Solution to Problem

The present invention provides the following pesticidal composition.

[1] A pesticidal composition comprising a compound represented by the formula (I), a herbicidal active salt, a surfactant and water, wherein

a pH value at 25° C. is higher than 3.5 and lower than 8.8:

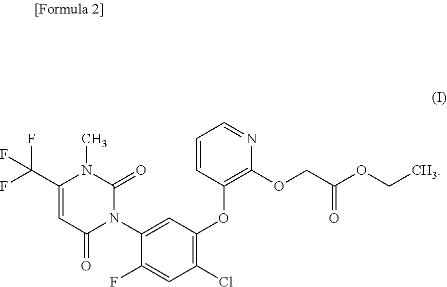 [SMILES: CCOC(=O)COc1ncccc1Oc1cc(-n2c(=O)cc(C(F)(F)F)n(C)c2=O)c(F)cc1Cl]

[2] A pesticidal composition comprising a compound represented by the formula (I), a herbicidal active salt, an organic solvent having a water solubility at 25° C. of 10 mass % or less, a surfactant and water, wherein

a pH value at 25° C. is higher than 3.5 and lower than 8.8:

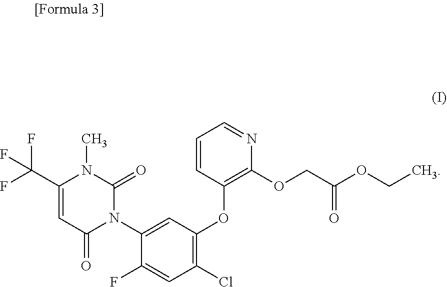 [SMILES: CCOC(=O)COc1ncccc1Oc1cc(-n2c(=O)cc(C(F)(F)F)n(C)c2=O)c(F)cc1Cl]

[3] The pesticidal composition according to [1], wherein the pH value is 4.2 or higher and 8.6 or lower.

[4] The pesticidal composition according to [2], wherein the pH value is 4.2 or higher and 8.6 or lower.

[5] The pesticidal composition according to any of [1] to [4], wherein the herbicidal active salt comprises a herbicidal active carboxylate.

[6] The pesticidal composition according to any of [1] to [4], wherein the herbicidal active salt comprises one or more herbicidal active salts selected from the group consisting of a herbicidal active benzoate and a herbicidal active phenoxyacetate.

[7] The pesticidal composition according to any of [1] to [4], wherein the herbicidal active salt comprises one or more herbicidal active salts selected from the group consisting of a dicamba salt and a 2,4-D salt.

[8] The pesticidal composition according to any of [1] to [4], wherein the herbicidal active salt comprises a dicamba salt.

[9] The pesticidal composition according to any of [1] to [4], wherein the herbicidal active salt comprises dicamba diglycolamine.

[10] The pesticidal composition according to any of [1] to [9], wherein the pesticidal composition contains an aqueous phase and particles of an oil phase dispersed in the aqueous phase, wherein the oil phase contains the organic solvent and the compound represented by the formula (I) dissolved or suspended in the organic solvent.

[11] The pesticidal composition according to any of [1] to [10], wherein the organic solvent comprises an aromatic hydrocarbon.

[12] The pesticidal composition according to any of [1] to [11], wherein the surfactant comprises a nonionic surfactant.

### Advantageous Effects of Invention

It is made possible to provide a liquid pesticidal composition comprising a compound represented by the formula (I) and a herbicidal active salt, wherein the liquid pesticidal composition has favorable degradation resistance of the compound represented by the formula (I).

### DESCRIPTION OF EMBODIMENTS

A pesticidal composition according to the present invention (hereinafter, also simply called “pesticidal composition”) contains a compound represented by the formula (I) (hereinafter, also called “compound (I)”), a herbicidal active salt, a surfactant and water. The pesticidal composition is usually a suspension containing an aqueous phase and the compound (I) suspended in the aqueous phase, or an oil-in-water emulsion containing an aqueous phase and particles of an oil phase dispersed in the aqueous phase. The oil phase contains the organic solvent having a water solubility at 25° C. of 10 mass % or less and the compound (I) dissolved or suspended in the organic solvent.

In the following, a detailed description will be given of ingredients that the pesticidal composition contains or may contain.

[1] Pesticidal Active Compound

The pesticidal composition contains the compound (I) as a first pesticidal active compound. In the pesticidal composition, the compound (I) may be suspended in water, or may be contained in the oil phase and dissolved or suspended in the organic solvent having a water solubility at 25° C. of 10 mass % or less, which constitutes the oil phase. In the pesticidal composition, it is desirable that the compound (I) be dissolved or suspended in the organic solvent constituting the oil phase.

With the total amount of the pesticidal composition being taken as 100 mass %, the content of the compound (I) in the pesticidal composition is preferably 0.01 mass % or more and 25 mass % or less, more preferably 0.05 mass % or more and 20 mass % or less, further preferably 0.1 mass % or more and 15 mass % or less, yet further preferably 0.2 mass % or more and 10 mass % or less, in view of moderately elevating the content.

The pesticidal composition contains one, two, or more herbicidal active salts as a second pesticidal active compound. Usually, the aqueous phase contains the herbicidal active salt(s). The herbicidal active salt is a herbicidal active compound in a salt form, and examples thereof include herbicidal active carboxylates, herbicidal active thiocarbonates, herbicidal active sulfonates, herbicidal active sulfinates, herbicidal active thiosulfonates or herbicidal active phosphites. The herbicidal active salt is preferably a herbicidal active carboxylate. A portion of the herbicidal active salt may be present in a neutral state in the pesticidal composition. For example, when the herbicidal active salt is carboxylates, the carboxylate group (—COO— group) of the salt may be present in equilibrium with a carboxy group (—COOH group).

Examples of the herbicidal active salt include herbicidal active carboxylates, herbicidal active thiocarbonates, herbicidal active sulfonates, herbicidal active sulfinates, herbicidal active thiosulfonates and herbicidal active phosphites listed in The Pesticide Manual Fifteenth Edition (2009), British Crop Production Council (ISBN: 978-1-901396-18-8), and examples of the herbicidal active carboxylate include salts of the following acids:
herbicidal active benzoates such as diflufenzopyr salt, naptalam salt, dicamba salt, and 2,3,6-trichlorobenzoic acid (2,3,6-TBA) salt;
herbicidal active pyrimidinyloxybenzoates such as bispyribac sodium;
herbicidal active pyrimidinylthiobenzoates such as pyrithiobac sodium; herbicidal active picolinic acid compounds such as aminopyralid salt, clopyralid salt, and picloram salt;
herbicidal active aromatic acid salts such as aminocyclopyrachlor salt and imazethapyr salts (e.g., imazethapyr ammonium);
herbicidal active phenoxyacetates such as (2,4-dichlorophenoxy)acetic acid (2,4-D) salt, MCPA (4-(4-chloro-o-tolyloxy)acetic acid) salt, and (2,4,5-trichlorophenoxy)acetic acid (2,4,5-T) salt;
herbicidal active phenoxybutyrates such as 4-(2,4-dichlorophenoxy)butyric acid (2,4-DB) salt and 4-(4-chloro-o-tolyloxy) butyric acid (MCPB) salt;
herbicidal active phenoxypropionates such as dichlorprop salt, dichlorprop-P salt, fenoprop salt, mecoprop salt, and mecoprop-P salt; and herbicidal active salts classified into carboxylic acid-containing organophosphorus herbicides such as glufosinate ammonium, glufosinate-P ammonium, and glyphosate salts (e.g., glyphosate potassium, glyphosate dimethylamine, glyphosate monoethanolamine, and glyphosate isopropylammonium).

The herbicidal active salt is preferably a herbicidal active carboxylate, more preferably one or more salts selected from the group consisting of herbicidal active benzoates and herbicidal active phenoxyacetates, further preferably one or more salts selected from the group consisting of dicamba salts and 2,4-D salts, yet further preferably a dicamba salt.

Examples of the dicamba salt include dicamba diglycolamine, dicamba tetrabutylamine, dicamba tetrabutylphosphonium and dicamba N,N-bis(3-aminopropyl)methylamine, with dicamba diglycolamine being preferable. The pesticidal composition can contain one, two, or more dicamba salts.

Examples of the 2,4-D salt include 2,4-D ammonium, 2,4-D diethylammonium, 2,4-D dimethylammonium, 2,4-D diolamine, 2,4-D dodecylammonium, 2,4-D heptylammonium, 2,4-D isopropylammonium, 2,4-D lithium, 2,4-D sodium, 2,4-D tetradecylammonium, 2,4-D triethylammonium, 2,4-D tris(2-hydroxypropyl)ammonium, 2,4-D trolamine, and 2,4-D choline. The pesticidal composition can contain one, two, or more 2,4-D salts.

With the total amount of the pesticidal composition being taken as 100 mass %, the content of the herbicidal active salt in the pesticidal composition is preferably 0.1 mass % or more and 80 mass % or less, more preferably 0.5 mass % or more and 70 mass % or less, further preferably 1 mass % or more and 60 mass % or less, yet further preferably 2 mass % or more and 50 mass % or less. The amount of the herbicidal active salt herein refers to an amount as the acid equivalent of the herbicidal active salt unless otherwise specified.

The pesticidal composition may contain a pesticidal active compound other than the compound (I) and the herbicidal active salt. Examples of the pesticidal active compound other than the compound (I) and the herbicidal active salt include, but are not particularly limited to, insecticidal active ingredients, fungicidal active ingredients and herbicidal active ingredients. The pesticidal composition can contain one or more pesticidal active ingredients selected from the group consisting of insecticidal active ingredients, fungicidal active ingredients and herbicidal active ingredients as the pesticidal active compound other than the compound (I) and the herbicidal active salt. Each of the insecticidal active ingredient, the fungicidal active ingredient and the herbicidal active ingredient may comprise one, two, or more ingredients.

With the total amount of the pesticidal active compound contained in the pesticidal composition being taken as 100 mass %, the total content of the compound (I) and the herbicidal active salt in all the pesticidal active compounds contained in the pesticidal composition is, for example, 50 mass % or more and 100 mass % or less. The content is preferably 60 mass % or more and 100 mass % or less, more preferably 80 mass % or more and 100 mass % or less, further preferably 90 mass % or more and 100 mass % or less, particularly preferably 95 mass % or more and 100 mass % or less.

The content of the herbicidal active salt relative to the content of the compound (I) is usually 1 time by mass or more and 100 times by mass or less, preferably 2 times by mass or more and 80 times by mass or less, more preferably 5 times by mass or more and 70 times by mass or less, further preferably 10 times by mass or more and 60 times by mass or less.

[2] Surfactant

The pesticidal composition contains one, two, or more surfactants. Examples of the surfactant include nonionic surfactants, anionic surfactants, cationic surfactants, and amphoteric surfactants. The pesticidal composition can contain one, two, or more surfactants selected from the group consisting of nonionic surfactants, anionic surfactants, cationic surfactants, and amphoteric surfactants.

Examples of the nonionic surfactant include:
block polymers such as polyoxyethylene polyoxypropylene block copolymers, and block polymers of alkanol, polyethylene oxide, and polypropylene oxide;
synthetic polymers such as vinyl acetate copolymers, polymethacrylic acid, and copolymers of methacrylic acid and methacrylic acid ester;
polyoxyalkylene fatty acid esters such as polyoxyethylene fatty acid esters (e.g., polyoxyethylene stearic acid ester), polyoxypropylene fatty acid esters (e.g., polyoxypropylene stearic acid ester) and polyoxyethylene polyoxypropylene fatty acid ester;
fatty acid esters such as fatty acid esters of polyol, monoglyceride, and phospholipids;
alcohol ethoxylates such as aliphatic alcohol ethoxylates (e.g., tridecyl alcohol ethoxylate, isooctyl alcohol ethoxylate, lauryl alcohol ethoxylate, hexadecyl alcohol ethoxylate, and stearyl alcohol ethoxylate), alkylphenol ethoxylates (e.g., nonylphenol ethoxylate, tristyrylphenol ethoxylate, tributylphenol ethoxylate, and octylphenol ethoxylate), arylalkylphenol ethoxylates, and arylphenol ethoxylates (e.g., monobenzylbiphenol alcohol ethoxylate);
alcohol propoxylates such as aliphatic alcohol propoxylate, alkylphenol propoxylate, and arylalkylphenol propoxylate;
polyoxyalkylene vegetable oils such as polyoxyethylene castor oil and polyoxyethylene polyoxypropylene castor oil;
polyoxyalkylene hydrogenated vegetable oils such as polyoxyethylene hydrogenated castor oil;
glycerin fatty acid esters;
glucose esters;
cellulose esters;
sucrose fatty acid esters (e.g., sucrose stearic acid diester);
polyvinyl alcohol;
sorbitan fatty acid esters (e.g., sorbitan laurate, sorbitan stearate, sorbitan oleate and sorbitan trioleate);
polyoxyalkylene sorbitan fatty acid esters (e.g., polyoxyethylene sorbitan laurate, polyoxyethylene sorbitan stearate, polyoxyethylene sorbitan oleate, and polyoxyethylene sorbitan trioleate);
fatty acid amine esters such as polyoxyethylene fatty acid amine ester and polyoxypropylene fatty acid amine ester;
polyoxyethylene rosin esters;
amides such as fatty acid alkanolamides (e.g., lauric acid diethanolamide), alkoxylated propylene oxide fatty acid glucamide, polyoxyethylene oleic acid amide, polyoxyethylene stearic acid amide, and polyvinylpyrrolidone;
amines such as alkoxylated amines (e.g., polyoxyethylene oleylamine, and α,α′-[(9-octadecenylimino)di-2,1-ethanediyl]bis(w-hydroxy)poly(oxyethylene)).

Examples of the anionic surfactant include:
sulfonates such as alkylsulfonates (e.g., dodecylsulfonate), alpha olefin sulfonates, alkylbenzenesulfonates (e.g., decylbenzenesulfonate, dodecylbenzenesulfonate, tridecylbenzenesulfonate, and diphenylsulfonate), alkylnaphthalenesulfonates (e.g., naphthalenesulfonate, dibutylnaphthalenesulfonate, 2,2′-dinaphthylmethane-6,6′-disulfonate, diisopropylnaphthalenesulfonate, and triisopropylnaphthalenesulfonate), dialkylsulfosuccinates (e.g., sodium di(2-ethylhexyl)sulfosuccinate), N-methyl-N-acyltaurine salts (e.g., methyl oleoyl taurate), other lignin sulfonates, alkylphenolsulfonates and derivatives thereof, naphthalenesulfonate-formaldehyde condensates and derivatives thereof, and benzimidazolesulfonate derivatives;
sulfuric acid ester salts such as alkyl sulfates (e.g., n-hexyl sulfate, n-heptyl sulfate, lauryl sulfate, lauryl sulfuric acid diethanol salt, and octadecyl sulfate), polyoxyethylene alkyl ether sulfates (e.g., laureth-3-sulfate), polyoxypropylene alkyl ether sulfates, and polyoxyethylene distyryl phenyl ether sulfuric acid ester salts;
carboxylates such as fatty acid salts such as octanoate, decanoate, laurate, myristate, palmitate, stearate, behenate, and oleate, and derivatives thereof, ether carboxylates such as laureth-3-carboxylate, and derivatives thereof, N-acylsarcosine salts such as N-lauroylsarcosine salt, and derivatives thereof, N-acylglutamates such as N-lauroylglutamate, and derivatives thereof, polyacrylates, polyvinyl acetates, and polycarboxylates such as comb-shaped polymers of polyacid salts, and derivatives thereof; and
phosphoric acid ester salts such as alkyl phosphates such as lauryl phosphate, and derivatives thereof, polyoxyethylene alkyl ether phosphates and derivatives thereof, polyoxyethylene alkyl phenyl ether phosphates and derivatives thereof, and polyoxypropylene alkyl ether phosphates and derivatives thereof.

Examples of the salt in the sulfonates, the sulfuric acid ester salts, the carboxylates, and the phosphoric acid ester salts include sodium salts, potassium salts, calcium salts, ammonium salts, isopropylamine salts, and triethanolamine salts.

Examples of the cationic surfactant include:
alkylamine salts such as monomethylamine salts, dimethylamine salts, trimethylamine salts, and dodecylamine salts;
fatty acid amide amine salts such as stearamide propyldimethylamine and behenamide propyldimethylamine;
polyamine salts such as polyvinylamine and polyethyleneimine; and
alkyl quaternary ammonium salts such as lauryltrimethylammonium salt, cetyltrimethylammonium salt, dodecyltrimethylammonium salts, stearylmethylammonium salts, ethylammonium benzylbis(2-chloroethyl)bromide salts, alkyldimethylbenzylammonium salts, alkylpyridinium salts, alkylisoquinolinium salts and dialkylmorpholinium salts.

Examples of the amphoteric surfactant include
N-laurylalanine, N,N,N-trimethylaminopropionic acid, N,N,N-trihydroxyethylaminopropionic acid, N-hexyl-N,N-dimethylaminoacetic acid, betaine, alkyl betaines (e.g., 1-(2-carboxyethyl)pyrimidinium betaine), imidazoline, taurine, alkyltaurine and lecithin.

As the surfactant, a commercially available surfactant may be used.

Examples of a commercially available nonionic surfactant include, in trade names, Selvol 523 (polyvinyl alcohol, manufactured by Sekisui Speciality Chemicals), Stepflow 26F (polyoxyethylene polyoxypropylene block copolymer, manufactured by Stepan), Toximul 8323 (polyoxyethylene polyoxypropylene block copolymer, manufactured by Stepan), Atlas G5000 (butyl block copolymer, manufactured by Croda), Atlas G5002L (butyl block copolymer, manufactured by Croda), Antarox B/848 (polyoxyethylene polyoxypropylene block copolymer, manufactured by Solvay), Pegnol 24-O (polyoxyethylene fatty acid ester, manufactured by TOHO Chemical Industry), Pegnol 14-S (polyoxyethylene fatty acid ester, manufactured by TOHO Chemical Industry), Pegnol ST-7 (polyoxyethylene alkyl ether, manufactured by TOHO Chemical Industry), ATPLUS245 (polyoxyethylene polyoxypropylene alkyl ether, manufactured by Croda), Synperonic AB6 (polyoxyalkylene alkyl ether, HLB: 12, manufactured by Croda), Brij O3 (polyoxyethylene oleyl ether, HLB: 7, manufactured by Croda), Genapol X060 (polyoxyethylene alkyl ether, manufactured by Clariant), Genapol X150 (polyoxyethylene alkyl ether, manufactured by Clariant), Emulsogen TS200 (polyoxyethylene tristyryl phenyl ether, manufactured by Clariant), Emulsogen TS290 (polyoxyethylene tristyryl phenyl ether, manufactured by Clariant), Emulsogen TS540 (polyoxyethylene tristyryl phenyl ether, manufactured by Clariant), Emulsogen TS600 (polyoxyethylene tristyryl phenyl ether, manufactured by Clariant), Emulsogen EL360 (polyoxyethylene castor oil, manufactured by Clariant), Emulsogen EL400 (polyoxyethylene castor oil, manufactured by Clariant), Emulsogen EL540 (polyoxyethylene castor oil, manufactured by Clariant), Solpol T26 (polyoxyethylene alkyl aryl ether, manufactured by TOHO Chemical Industry), Alkamuls OR/40 (polyoxyethylene castor oil, manufactured by Solvay), Toximul 8240 (polyoxyethylene castor oil, molar number of added EO: 36, manufactured by Stepan), Toximul 8241 (polyoxyethylene castor oil, molar number of added EO: 30, manufactured by Stepan), Toximul 8242 (polyoxyethylene castor oil, molar number of added EO: 40, manufactured by Stepan), NIKKOL HCO-20 (polyoxyethylene hydrogenated castor oil, manufactured by Nikko Chemicals), Geronol TE/250 (mixture of polyoxyethylene castor oil and polyoxyethylene polyoxypropylene monobutyl ether, manufactured by Solvay), NIKKOL MGU (glycerol fatty acid ester, manufactured by Nikko Chemicals), NIKKOL DGS-80 (glycerol fatty acid ester, manufactured by Nikko Chemicals), Newcol 20 (sorbitan laurate, manufactured by Nippon Nyukazai), and Newcol 25 (polyoxyethylene sorbitan laurate, manufactured by Nippon Nyukazai).

Examples of a commercially available anionic surfactant include, in trade names, Rhodacal 70 (calcium dodecylbenzenesulfonate, branched, manufactured by Solvay), Rhodacal 70/B (calcium dodecylbenzenesulfonate, linear, manufactured by Solvay), Rhodacal LDS-25/AP (sodium dodecylbenzenesulfonate, linear, manufactured by Solvay), Calsogen 4814 (calcium dodecylbenzenesulfonate, manufactured by Clariant), Phenylsulfonat CAL (calcium dodecylbenzenesulfonate, manufactured by Clariant), Geropon CYA/75 (sodium di(2-ethylhexyl) sulfosuccinate, manufactured by Solvay), and Soprophor DSS/7 (polyoxyethylene distyryl phenyl ether sulfuric acid ester ammonium salt, manufactured by Solvay).

With the total amount of the pesticidal composition being taken as 100 mass %, the content of the surfactant in the pesticidal composition is preferably 0.5 mass % or more and 30 mass % or less, more preferably 0.7 mass % or more and 25 mass % or less, further preferably 0.8 mass % or more and 20 mass % or less, yet further preferably 1 mass % or more and 15 mass % or less, particularly preferably 1.5 mass % or more and 10 mass % or less, in view of improving the suspended or emulsified state of the pesticidal composition.

The content of the surfactant relative to the content of the pesticidal active compound is preferably 0.05 times by mass or more and 30 times by mass or less, more preferably 0.07 times by mass or more and 25 times by mass or less, further preferably 0.1 times by mass or more and 20 times by mass or less, particularly preferably 0.1 times by mass or more and 15 times by mass or less.

[3] Water

The pesticidal composition contains water. Examples of the water include ion-exchange water, tap water and groundwater. The water constitutes the aqueous phase of the pesticidal composition.

With the total amount of the pesticidal composition being taken as 100 mass %, the content of the water in the pesticidal composition is preferably 30 mass % or more and 95 mass % or less, more preferably 35 mass % or more and 93 mass % or less, further preferably 40 mass % or more and 90 mass % or less, yet further preferably 45 mass % or more and 87 mass % or less. For improving the suspended or emulsified state of the pesticidal composition, it is preferable that the pesticidal composition contain the water at a content within the range.

[4] Organic Solvent

The pesticidal composition may contain an organic solvent having a water solubility at 25° C. of 10 mass % or less. Hereinafter, this organic solvent is also called “organic solvent A”. The organic solvent A may dissolve the compound (I). The pesticidal composition may contain one, two, or more organic solvents A.

The water solubility at 25° C. of the organic solvent A may be, for example, 8 mass % or less, may be 5 mass % or less, may be 3 mass % or less, and may be 1 mass % or less. It is preferable that the pesticidal composition contain the organic solvent A having water solubility within the range because the emulsified state of the pesticidal composition is improved. The water solubility at 25° C. of the organic solvent A is usually 0 mass % or more and may be 10⁻⁵ mass % or more.

The water solubility at 25° C. herein refers to the solubility in water at a temperature of 25° C. and pH 7. For example, a water solubility at 25° C. of 10 mass % means that the solubility in 1 g of water at a temperature of 25° C. and pH 7 is 1×10⁻¹ g.

As the water solubility of the organic solvent, a value found in the database (Solubility Database) of International Union of Pure and Applied Chemistry (IUPAC) or National Institute of Standards and Technology (NIST) may be used. When a corresponding value is not found in the database, the water solubility of the organic solvent may be measured by determining the saturation solubility in water at a temperature of 25° C. and pH 7 by high-performance liquid chromatography.

Examples of the organic solvent A that may be contained in the pesticidal composition include:
alcohols such as butanol, amyl alcohol, hexanol, heptanol, octanol, 2-ethylhexanol, cyclohexanol and benzyl alcohol;
esters such as acetic acid esters (e.g., ethyl acetate, butyl acetate, isoamyl acetate, isobornyl acetate, hexyl acetate, heptyl acetate, octyl acetate, and benzyl acetate), carbonic acid esters (e.g., diethyl carbonate and dibutyl carbonate), fatty acid esters (e.g., isopropyl myristate, methyl octanoate, methyl oleate, methyl laurate, dimethyl adipate, dibutyl adipate, didecyl adipate, tri-n-butyl citrate, di-n-butyl phthalate, methyl caprylate, methyl laurate, methyl myristate, methyl salicylate, methyl palmitate, methyl oleate, and ethyl palmitate), phthalic acid esters (e.g., dimethyl phthalate and diethyl phthalate), benzoic acid esters (e.g., methyl benzoate and ethyl benzoate), succinic acid esters (e.g., dioctyl succinate), and acetoacetic acid esters (e.g., tert-butyl acetoacetate and allyl acetoacetate);
ethers such as propylene glycol phenyl ether;
ketones such as cyclohexanone, 2-heptanone, isophorone, mesityl oxide, methyl isoamyl ketone, methyl isobutyl ketone, methylcyclohexanone, and acetophenone;
amides such as fatty acid dimethylamides (e.g., N,N-dimethyldecanamide, N,N-dimethyldodecanamide, N,N-dimethyltetradecanamide, and N,N-dimethyloctadecanamide), and alkylpyrrolidones (e.g., N-octyl-pyrrolidone, N-dodecyl-pyrrolidone, and N-decyl-pyrrolidone);
lactones such as γ-octanolactone and δ-octanolactone;
amines such as n-octylamine, oleylamine, and laurylamine;
aliphatic hydrocarbons such as decane, tridecane, tetradecane, hexadecane, octadecane, normal paraffin, isoparaffin, cycloparaffin, 1-undecene and 1-heneicosene;
aromatic hydrocarbons such as toluene, xylene, alkylbenzenes such as ethylbenzene, octadecylbenzene, dialkylbenzene and trialkylbenzene, alkylnaphthalenes such as methylnaphthalene, dimethylnaphthalene, dodecylnaphthalene and tridecylnaphthalene, and phenylxylylethane and 1-phenyl-1-ethylphenylethane, and a mixture of these;
fatty acids such as oleic acid, capric acid, and enanthic acid;
animal- or vegetable-derived oils such as coconut oil, olive oil, soybean oil, rape oil, castor oil, linseed oil, cottonseed oil, palm oil, avocado oil, shark liver oil, sardine oil, and saury oil;
mineral oils such as naphtha, petroleum ether, kerosene, diesel oil, paraffin, olefin, and machine oil; and
silicone oil.

As the organic solvent A, a commercially available solvent may be used. Examples of the commercially available product include, in trade names, Agnique AMD810 (mixture of N,N-dimethyloctanamide and N,N-dimethyldecanamide, manufactured by BASF), Agnique AMD10 (N,N-dimethyldecanamide, manufactured by BASF), Agnique AMD12 (N,N-dimethyldodecanamide, manufactured by BASF), Rhodiasolv ADMA810 (mixture of N,N-dimethyloctanamide and N,N-dimethyldecanamide, manufactured by Solvay Nicca), Rhodiasolv ADMA-10 (N,N-dimethyldecanamide, manufactured by Solvay Nicca), Hallcomid M-8-10 (mixture of N,N-dimethyloctanamide and N,N-dimethyldecanamide, manufactured by Stepan), Hallcomid M-10 (N,N-dimethyldecanamide, manufactured by Stepan), Hallcomid M-12 (N,N-dimethyldodecanamide, manufactured by Stepan), Hallcomid M-18 (N,N-dimethyloctadecanamide, manufactured by Stepan), Hallcomid 1025 (N,N-dimethyl-9-deceneamide, manufactured by Stepan), Genagen 4166 (fatty acid dimethylamide, manufactured by Clariant), Genagen 4296 (fatty acid dimethylamide, manufactured by Clariant), Rhodiasolv Iris (mixture of dimethyl 2-methylglutarate, dimethyl 2-ethylsuccinate, and dimethyl adipate, manufactured by Solvay), PURASOLV EHL (2-ethylhexyl-L-lactate, manufactured by Corbion purac), AGSOLEX 8 (N-octyl-pyrrolidone, manufactured by Ashland), AGSOLEX 12 (N-dodecyl-pyrrolidone, manufactured by Ashland), Stepan C-25 (methyl caprylate, manufactured by Stepan), Stepan C-42 (mixture of methyl laurate and methyl myristate, manufactured by Stepan), Stepan C-65 (mixture of methyl palmitate and methyl oleate, manufactured by Stepan), Dowanol PPh (propylene glycol phenyl ether, manufactured by Dow Chemical), Nisseki Hisol SAS-296 (mixture of 1-phenyl-1-xylylethane and 1-phenyl-1-ethylphenylethane, manufactured by JX Nippon Oil & Energy), SOLVESSO 100 (containing C9-C10 dialkyl- and trialkylbenzene as its main aromatic hydrocarbon, manufactured by ExxonMobil Chemical), SOLVESSO 150 (containing C10-C11 alkyl benzene as its main aromatic hydrocarbon, manufactured by ExxonMobil Chemical), SOLVESSO 150ND (containing C10-C11 alkyl benzene as its main aromatic hydrocarbon, manufactured by ExxonMobil Chemical), SOLVESSO 200 (containing C10-C13 alkyl naphthalene as its main aromatic hydrocarbon, manufactured by ExxonMobil Chemical), and SOLVESSO 200ND (containing C10-C13 alkyl naphthalene as its main aromatic hydrocarbon, manufactured by ExxonMobil Chemical).

In view of the solubility of the compound (I) and an emulsified state of the pesticidal composition, the organic solvent A preferably comprises one or more selected from the group consisting of aromatic hydrocarbons, aliphatic hydrocarbons, ketones, esters, ethers, amides, amines, and alcohols, and more preferably comprises an aromatic hydrocarbon. The aromatic hydrocarbon preferably comprises one or more selected from the group consisting of alkylbenzenes (e.g., toluene, xylene, ethylbenzene, octadecylbenzene, dialkylbenzene and trialkylbenzene), alkylnaphthalenes (e.g., methylnaphthalene, dimethylnaphthalene, dodecylnaphthalene and tridecylnaphthalene), and phenylxylylethane and 1-phenyl-1-ethylphenylethane, more preferably comprises one or more selected from the group consisting of alkylbenzenes and alkylnaphthalenes, and further preferably comprises one or more selected from the group consisting of C9-C12 alkylbenzenes and C10-C15 alkylnaphthalenes. The organic solvent A may consist of an aromatic hydrocarbon.

With the total amount of the pesticidal composition being taken as 100 mass %, the content of the organic solvent A in the pesticidal composition is preferably 0.1 mass % or more and 45 mass % or less, more preferably 0.5 mass % or more and 40 mass % or less, further preferably 1 mass % or more and 35 mass % or less, yet further preferably 3 mass % or more and 30 mass % or less. It is preferable that the pesticidal composition contain the organic solvent A at a content within the range in view of moderately elevating the content of the compound (I) and improving the emulsified state of the pesticidal composition.

The content of the organic solvent A relative to the content of the compound (I) is usually 3 times by mass or more and 35 times by mass or less, preferably 4 times by mass or more and 30 times by mass or less, more preferably 5 times by mass or more and 25 times by mass or less, further preferably 5 times by mass or more and 20 times by mass or less, particularly preferably 7 times by mass or more and 15 times by mass or less. In view of moderately elevating the content of the compound (I) and improving the emulsified state of the pesticidal composition, it is preferable that the ratio (mass ratio) of the content of the organic solvent A to the content of the compound (I) be adjusted to within the range.

The content of the organic solvent A relative to that of the surfactant is preferably 0.05 times by mass or more and 100 times by mass or less, more preferably 0.1 times by mass or more and 50 times by mass or less, further preferably 0.12 times by mass or more and 30 times by mass or less, particularly preferably 0.15 times by mass or more and 20 times by mass or less.

When the pesticidal composition contains two or more organic solvents A, the content of the organic solvent A mentioned above is the total content of the two or more organic solvents A. The same holds true for other ingredients that the pesticidal composition contains or may contain, and the content of each ingredient is the total content of two or more ingredients, if contained, unless otherwise specified.

The pesticidal composition can contain an organic solvent other than the organic solvent A. However, for improving the emulsified state of the pesticidal composition, it is preferable that the organic solvent contained in the pesticidal composition consist of the organic solvent A.

[5] Other Ingredients

The pesticidal composition may contain a formulation aid. Examples of other formulation aids include thickeners, antifoaming agents, antifreezing agents, and antiseptics.

Examples of the thickener include polysaccharides such as xanthan gum, guar gum, welan gum, diutan gum, and cellulose nanofibers, clay, and silicates. With the total amount of the pesticidal composition being taken as 100 mass %, the content of the thickener in the pesticidal composition is usually 0.00 mass % or more and may be 0.05 mass % or more, and is usually 5 mass % or less and may be 3 mass % or less.

Examples of the antifoaming agent include silicone-based antifoaming agents. With the total amount of the pesticidal composition being taken as 100 mass %, the content of the antifoaming agent in the pesticidal composition is usually 0.01 mass % or more and may be 0.05 mass % or more, and is usually 1 mass % or less and may be 0.5 mass % or less.

Examples of the antifreezing agent include ethylene glycol, propylene glycol, urea, and glycerin. With the total amount of the pesticidal composition being taken as 100 mass %, the content of the antifreezing agent in the pesticidal composition is usually 1 mass % or more and may be 2 mass % or more, and is usually 10 mass % or less and may be 8 mass % or less.

Examples of the antiseptic include isothiazolinone-based antiseptics. With the total amount of the pesticidal composition being taken as 100 mass %, the content of the antiseptic in the pesticidal composition is usually 0.05 mass % or more and may be 0.1 mass % or more, and is usually 0.5 mass % or less and may be 0.3 mass % or less.

The suspension of the compound (I) suspended in water can be prepared, for example, as follows: the compound (I) which is a pesticidal active compound, water, the herbicidal active salt, the surfactant and an optional formulation aid are milled and suspended by wet milling using a medium such as glass beads or zirconia to obtain a suspension. The suspension may or may not contain the herbicidal active salt. The herbicidal active salt, if not contained therein, is mixed with the suspension. The suspension is mixed with an optional formulation aid such as a thickener, an antiseptic, and an antifoaming agent to obtain a pesticidal composition.

The oil-in-water emulsion of the compound (I) contained in an oil phase can be prepared, for example, as follows: the compound (I) which is a pesticidal active compound, the organic solvent A and an optional surfactant are mixed to prepare an oil phase. The herbicidal active salt, a formulation aid, water and an optional surfactant are added to prepare an aqueous phase. The aqueous phase may or may not contain the herbicidal active salt. The surfactant may be added to the organic solvent, may be added to the water, or may be added to both. The oil phase is added to the aqueous phase and emulsified using a stirrer such as a homogenizer, and the resultant is mixed with an optional formulation aid such as a thickener, an antiseptic, and an antifoaming agent to obtain a pesticidal composition.

The surfactant may be added at a plurality of timings. For example, the process of obtaining a suspension and/or an emulsified liquid in the presence of a portion of the surfactant may be carried out, followed by the addition of another portion of the surfactant.

[6] pH Value of Pesticidal Composition

The pH value at 25° C. of the pesticidal composition is higher than 3.5 and lower than 8.8. The pH value falls within the range, whereby a pesticidal composition having favorable degradation resistance of the compound (I) can be provided. The pesticidal composition has, for example, a high residual rate of the compound (1) after being stored in a high-temperature environment.

The pH value of the pesticidal composition can be measured by a method mentioned later.

The pH value of the pesticidal composition is higher than 3.5 and lower than 8.8. The pH value is preferably 4.2 or higher and 8.6 or lower. The pH value is more preferably 4.5 or higher, further preferably 4.6 or higher, and may be 4.8 or higher, may be 4.9 or higher, may be 5.0 or higher, and may be 5.1 or higher. The pH value is preferably 8.5 or lower, more preferably 8.0 or lower, and may be 7.9 or lower, may be 7.8 or lower, may be 7.7 or lower, may be 7.6 or lower, and may be 7.5 or lower.

The residual rate of the compound (I) that is calculated according to an expression mentioned below after the pesticidal composition is stored at a temperature of 54° C. for 2 weeks is preferably 75% or more, more preferably 80% or more, further preferably 85% or more, yet further preferably 90% or more, particularly preferably 95% or more, most preferably 97% or more.

[7] Use of Pesticidal Composition

The pesticidal composition can be suitably used as a liquid pesticidal formulation called suspension concentrate (SC) or emulsion oil in water (EW) in the pesticidal field.

The pesticidal composition can be used in crop lands such as dry fields, orchard fields, pastures, lawn fields, and forestry fields; and non-crop lands such as levee slopes, riverbeds, shoulders and slopes of the roads, railroads, parks and green spaces, playgrounds, automobile parks, airports, and industrial plant sites such as factories and storage facilities as well as idle fields and urban deserts, thereby controlling weeds.

Users prepare a suspension or an emulsified liquid by usually mixing the pesticidal composition with water, and applies the suspension or the emulsified liquid from a knapsack sprayer, a spray tank, a spray plane, or an irrigation system. The amount of spray differs depending on climate conditions, the timing of treatment, soil conditions, target crops, target weeds, etc. and is usually 10 L or more and 2000 L or less, preferably 50 L or more and 400 L or less, per hectare. Also, the suspension or the emulsified liquid is prepared by mixing the pesticidal composition with water in usually from 2 to 10000 times, preferably from 10 to 8000 times, more preferably from 15 to 6000 times the volume of the suspension concentrate or the emulsion oil in water.

In applying the suspension or the emulsified liquid, it may be mixed with an adjuvant. Although the type of the adjuvant is not particularly limited, it is preferable to mix an oil-based adjuvant (methylated seed oil in which a mineral oil such as a paraffinic hydrocarbon, a naphthenic hydrocarbon, or an aromatic hydrocarbon, or a vegetable oil (soybean oil or rapeseed oil) is esterified) such as Agri-Dex or MSO at 0.25%, 0.5%, 1%, 2%, 3%, 4%, 5% or 6% (volume/volume) into the spray liquid, or a nonionic adjuvant (polyoxyalkylene alkyl ether, polyoxyalkylene fatty acid ester, alkylaryl alkoxylate, or alkylaryl polyoxyalkylene glycol) such as Induce at 0.05%, 0.1%, 0.25%, or 0.5% (volume/volume) into the spray liquid. Other examples thereof include anionic series (substituted sulfonates) such as Gramin S, cationic series (polyoxyethyleneamine) such as Genamin T 200BM, and organic silicone series such as Silwet L77. Furthermore, a drift control agent such as Intact (polyethylene glycol) may be mixed. The pH or hardness of the spray liquid is not particularly limited.

### EXAMPLES

In the following, the present invention will be described in further detail with reference to Examples and Comparative Examples, etc. The scope of the present invention is not limited to these Examples.

The products used in the preparation of pesticidal compositions will be given below.

[1] Dicamba DGA: Dicamba diglycolamine salt (an aqueous solution of 59 mass % of the salt (40 mass % as an acid) was used for the preparation of pesticidal compositions, whereas the amounts specified in Table 1 are the amounts of the dicamba diglycolamine itself.)

[2] Solvesso 200ND: Containing C10-C13 alkylnaphthalene as its main aromatic hydrocarbon, manufactured by ExxonMobil Chemical

[3] Alkamuls OR/40: Polyoxyethylene castor oil, the number of added EO: 40, manufactured by Solvay

[4] Keltrol CG-LAX-T: Xanthan gum, manufactured by CP KELCO

### Production Example 1

0.88 parts by mass of the compound (I) active substance (purity: 98 mass %) and 5.00 parts by mass of Alkamuls OR/40 were dissolved in 9.15 parts by mass of Solvesso 200ND to obtain a solution. The solution was emulsified in 22.54 parts by mass of an aqueous Dicamba DGA solution (acid equivalent concentration: 40 mass %) using Polytron homogenizer (manufactured by KINEMATICA) to obtain an emulsified liquid. A thickening agent obtained by mixing 0.11 parts by mass of Keltrol CG-LAX-T and 10.89 parts by mass of water at 60° C., the emulsified liquid, 14.22 parts by mass of water, and 37.21 mass % of an aqueous Dicamba DGA solution (acid equivalent concentration: 40 mass %) were mixed and stirred, and the resultant was mixed with 1.5 mL of an aqueous solution of 85 mass % H₃PO₄ to obtain a pesticidal composition 2.

The units of the values of each ingredient specified in Table 1 are mass % with the total amount of the pesticidal composition being taken as 100 mass %.

### Production Example 2

0.88 parts by mass of the compound (I) active substance (purity: 98 mass %) were dissolved in 9.15 parts by mass of Solvesso 200ND to obtain a solution. The solution was emulsified in an aqueous solution containing 5.00 parts by mass of Alkamuls OR/40 dissolved in 59.75 parts by mass of an aqueous Dicamba DGA solution (acid equivalent concentration: 40 mass %) using Polytron homogenizer (manufactured by KINEMATICA) to obtain an emulsified liquid. A thickening agent obtained by mixing 0.11 parts by mass of Keltrol CG-LAX-T and 14.80 parts by mass of water at 60° C., the emulsified liquid, and 10.31 parts by mass of water were mixed and stirred, and the resultant was mixed with 0.5 mL of an aqueous solution of 85 mass % H₃PO₄ to obtain a pesticidal composition 3.

### Production Example 3

0.88 parts by mass of the compound (I) active substance (purity: 98 mass %) were dissolved in 9.15 parts by mass of Solvesso 200ND to obtain a solution. The solution was emulsified in an aqueous solution containing 5.00 parts by mass of Alkamuls OR/40 dissolved in 59.75 parts by mass of an aqueous Dicamba DGA solution (acid equivalent concentration: 40 mass %) using Polytron homogenizer (manufactured by KINEMATICA) to obtain an emulsified liquid. A thickening agent obtained by mixing 0.11 parts by mass of Keltrol CG-LAX-T and 14.80 parts by mass of water at 60° C., the emulsified liquid, and 10.31 parts by mass of water were mixed and stirred, and the resultant was mixed with 0.5 mL of an aqueous solution of 1 mol/L HCL to obtain a pesticidal composition 4.

### Production Example 4

0.88 parts by mass of the compound (I) active substance (purity: 98 mass %) were dissolved in 9.15 parts by mass of Solvesso 200ND to obtain a solution. The solution was emulsified in an aqueous solution containing 5.00 parts by mass of Alkamuls OR/40 dissolved in 59.75 parts by mass of an aqueous Dicamba DGA solution (acid equivalent concentration: 40 mass %) using Polytron homogenizer (manufactured by KINEMATICA) to obtain an emulsified liquid. A thickening agent obtained by mixing 0.11 parts by mass of Keltrol CG-LAX-T and 14.80 parts by mass of water at 60° C., the emulsified liquid, and 10.31 parts by mass of water were mixed and stirred to obtain a pesticidal composition 5.

### Production Example 5

0.88 parts by mass of the compound (I) active substance (purity: 98 mass %) and 5.00 parts by mass of Alkamuls OR/40 were dissolved in 9.15 parts by mass of Solvesso 200ND to obtain a solution. The solution was emulsified in 22.54 parts by mass of an aqueous Dicamba DGA solution (acid equivalent concentration: 40 mass %) using Polytron homogenizer (manufactured by KINEMATICA) to obtain an emulsified liquid. A thickening agent obtained by mixing 0.11 parts by mass of Keltrol CG-LAX-T and 10.89 parts by mass of water at 60° C., the emulsified liquid, 14.22 parts by mass of water, and 37.21 parts by mass of an aqueous Dicamba DGA solution (acid equivalent concentration: 40 mass %) were mixed and stirred, and the resultant was mixed with 0.4 mL of an aqueous solution of 50 (wt/vol) % NaOH to obtain a pesticidal composition 6.

### Comparative Production Example 1

0.88 parts by mass of the compound (I) active substance (purity: 98 mass %) and 5.00 parts by mass of Alkamuls OR/40 were dissolved in 9.15 parts by mass of Solvesso 200ND to obtain a solution. The solution was emulsified in 22.54 parts by mass of an aqueous Dicamba DGA solution (acid equivalent concentration: 40 mass %) using Polytron homogenizer (manufactured by KINEMATICA) to obtain an emulsified liquid. A thickening agent obtained by mixing 0.11 parts by mass of Keltrol CG-LAX-T and 10.89 parts by mass of water at 60° C., the emulsified liquid, 14.22 parts by mass of water, and 37.21 parts by mass of an aqueous Dicamba DGA solution (acid equivalent concentration: 40 mass %) were mixed and stirred, and the resultant was mixed with 4.3 mL of an aqueous solution of 85 mass % H₃PO₄ to obtain a pesticidal composition 1.

### Comparative Production Example 2

0.88 parts by mass of the compound (I) active substance (purity: 98 mass %) were dissolved in 9.15 parts by mass of Solvesso 200ND to obtain a solution. The solution was emulsified in an aqueous solution containing 5.00 parts by mass of Alkamuls OR/40 dissolved in 59.75 parts by mass of an aqueous Dicamba DGA solution (acid equivalent concentration: 40 mass %) using Polytron homogenizer (manufactured by KINEMATICA) to obtain an emulsified liquid. A thickening agent obtained by mixing 0.11 parts by mass of Keltrol CG-LAX-T and 14.80 parts by mass of water at 60° C., the emulsified liquid, 10.31 parts by mass of water, and 1.0 mL of an aqueous solution of 50 (wt/vol)/o NaOH were mixed to obtain a pesticidal composition 7.

### Test Example 1: pH Value of Pesticidal Composition

The pesticidal composition (temperature: 25° C.) immediately after preparation was placed in a glass vessel and shaken by manual shaking. The electrode of a pH meter (“model F-13” manufactured by HORIBA, Ltd.) was dipped in the pesticidal composition, and the pH value was measured.

### Test Example 2: Degradation Resistance of Compound (I)

A content C1 of the compound (I) in the pesticidal composition immediately after preparation was measured using HPLC (“20 Series” manufactured by Shimadzu Corp.). The pesticidal composition was placed in a glass vessel and stored at 54° C. Two weeks after the storage started, a content C2 of the compound (I) in the pesticidal composition was measured using HPLC (“20 Series” manufactured by Shimadzu Corp.).

On the basis of the measurement results, the residual rate of the compound (I) was determined according to an expression given below. The results are shown in Table 1.

Residual rate (%) of the compound (I)=100×C2/C1

TABLE 1

| Pesticidal composition | | | | | | |
|---|---|---|---|---|---|---|
| 1 | 2 | 3 | 4 | 5 | 6 | 7 |

| | | |
|---|---|---|
| Pesticidal active compound | Compound (I) (purity: 98%) | 0.88 |
| | Dicamba DGA | 35.25 |
| Organic solvent | Solvesso 200ND | 9.15 |
| Surfactant | Alkamuls OR/40 | 5.00 |
| Thickener | Keltrol CG-LAX-T | 0.11 |

| Water | 49.61 | | | | | | |
|---|---|---|---|---|---|---|---|
| Total | 100.00 | | | | | | |
| pH value (25° C.) | 3.5 | 4.2 | 4.8 | 6.9 | 7.5 | 8.6 | 8.8 |
| Residual rate (%) of compound (I) | 44.1 | 75.3 | 92.5 | 97.9 | 97.8 | 76.8 | 53.2 |

1. A pesticidal composition comprising a compound represented by the formula (I), a herbicidal active salt, a surfactant and water, wherein
a pH value at 25° C. is higher than 3.5 and lower than 8.8:

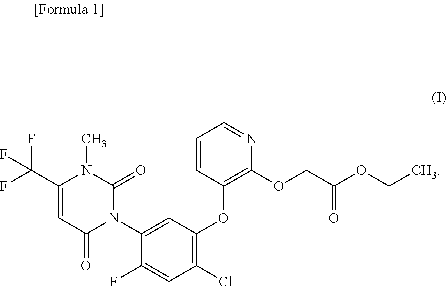 [SMILES: CCOC(=O)COc1ncccc1Oc1cc(-n2c(=O)cc(C(F)(F)F)n(C)c2=O)c(F)cc1Cl]

2. A pesticidal composition comprising a compound represented by the formula (I), a herbicidal active salt, an organic solvent having a water solubility at 25° C. of 10 mass % or less, a surfactant and water, wherein
a pH value at 25° C. is higher than 3.5 and lower than 8.8:

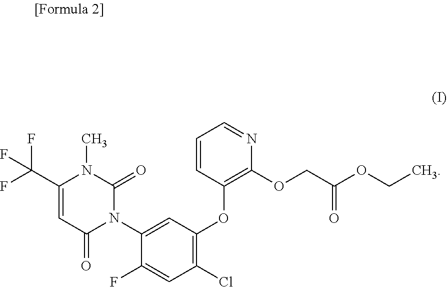 [SMILES: CCOC(=O)COc1ncccc1Oc1cc(-n2c(=O)cc(C(F)(F)F)n(C)c2=O)c(F)cc1Cl]

3. The pesticidal composition according to claim 1, wherein the pH value is 4.2 or higher and 8.6 or lower.

4. The pesticidal composition according to claim 2, wherein the pH value is 4.2 or higher and 8.6 or lower.

5. The pesticidal composition according to claim 1, wherein the herbicidal active salt comprises a herbicidal active carboxylate.

6. The pesticidal composition according to claim 1, wherein the herbicidal active salt comprises one or more herbicidal active salts selected from the group consisting of a herbicidal active benzoate and a herbicidal active phenoxyacetate.

7. The pesticidal composition according to claim 1, wherein the herbicidal active salt comprises one or more herbicidal active salts selected from the group consisting of a dicamba salt and a 2,4-D salt.

8. The pesticidal composition according to claim 1, wherein the herbicidal active salt comprises a dicamba salt.

9. The pesticidal composition according to claim 1, wherein the herbicidal active salt comprises dicamba diglycolamine.

10-11. (canceled)

12. The pesticidal composition according to claim 1, wherein the surfactant comprises a nonionic surfactant.

13. The pesticidal composition according to claim 2, wherein the herbicidal active salt comprises a herbicidal active carboxylate.

14. The pesticidal composition according to claim 2, wherein the herbicidal active salt comprises one or more herbicidal active salts selected from the group consisting of a herbicidal active benzoate and a herbicidal active phenoxyacetate.

15. The pesticidal composition according to claim 2, wherein the herbicidal active salt comprises one or more herbicidal active salts selected from the group consisting of a dicamba salt and a 2,4-D salt.

16. The pesticidal composition according to claim 2, wherein the herbicidal active salt comprises a dicamba salt.

17. The pesticidal composition according to claim 2, wherein the herbicidal active salt comprises dicamba diglycolamine.

18. The pesticidal composition according to claim 2, wherein the pesticidal composition contains an aqueous phase and particles of an oil phase dispersed in the aqueous phase, wherein
the oil phase contains the organic solvent and the compound represented by the formula (I) dissolved or suspended in the organic solvent.

19. The pesticidal composition according to claim 2, wherein the organic solvent comprises an aromatic hydrocarbon.

20. The pesticidal composition according to claim 2, wherein the surfactant comprises a nonionic surfactant.
